(19) United States
(12) Patent Application Publication
(10) Pub. No.: US 2009/0320508 A1
(43) Pub. Date: Dec. 31, 2009

(54) DUAL COMPRESSOR COOLER

(76) Inventor: Nathan Linder, West Covina, CA (US)

Correspondence Address: STETINA BRUNDA GARRED & BRUCKER, 75 ENTERPRISE, SUITE 250, ALISO VIEJO, CA, 92656, US

(21) Appl. No.: 12/492,032

(22) Filed: Jun. 25, 2009

Related U.S. Application Data
(60) Provisional application No. 61/076,522, filed on Jun. 27, 2008.

(51) Int. Cl. A47F 3/04; F25B 7/00; F25D 27/00; B67D 5/62

(52) U.S. Cl. 62/251; 62/335; 62/264; 62/389

(57) ABSTRACT

A dual compressor beverage cooler having a central beverage storage area and at least one external beverage dispensing unit. A first compressor maintains the central beverage storage area at typical refrigeration temperatures and a second compressor maintains the external beverage dispensing units at below freezing temperatures. The central beverage storage area may house “energy” drinks and the external beverage dispensing units may house alcoholic drinks.

### CROSS-REFERENCE TO RELATED APPLICATIONS

The present application relates to and claims the benefit of U.S. Provisional Patent Application Ser. No. 61/076,522 filed on Jun. 27, 2008 entitled DUAL COMPRESSOR COOLER, the teachings of which are incorporated herein by reference.

### STATEMENT RE: FEDERALLY SPONSORED RESEARCH/DEVELOPMENT

Not Applicable

### BACKGROUND

1. Field of the Invention

The present invention relates generally to dual compressor cooling unit. In particular, the present invention relates to a dual compressor cooling unit for maintaining multiple beverages at different temperatures.

2. Background of the Invention

Beverage cooling and storage systems are known within the art and are widely utilized in personal, retail, and service settings. In particular, refrigerated beverage display systems are widely utilized in retail settings as well as bar and restaurant settings for the marketing of particular beverages. These display systems typically consist of a refrigerated unit and a clear glass front door for displaying the contents of the refrigerated unit and possible some badging or branding of the beverage on the outside of the refrigerated unit.

Additionally, the popularity of so-called “energy” drinks has risen dramatically recently. “Energy” drinks may be thought of as soft drinks that are advertised as providing more energy than a typical drink and usually contain supplemental ingredients that are believed to contribute to increased mental alertness and/or physical performance. Typical supplemental ingredients in these “energy” drinks include caffeine, B vitamins, guarana, taurine, ginseng, inositol, carnitine, creatine, glucuronolactone, ginko boloba, and various herbs. Due to the increased mental alertness provided by many of these “energy” drinks, people have begun mixing “energy” drinks with alcoholic beverages in order to counterbalance the drowsiness induced by consuming alcoholic beverages. Although there have been some attempts at marketing beverages containing both alcohol and “energy” supplements, these combination drinks have not become very successful and are not widespread.

As such, the typical consumer who desires to consume a combination alcoholic/energy beverage usually must mix his own beverage by combining separate alcoholic and “energy” drinks. Vodka is a typical alcoholic beverage mixed with “energy” drinks due to its clear color and relative lack of odor and taste. By mixing vodka with an “energy” drink, the consumer is able to retain much of the taste and odor of the “energy” drink. Accordingly, there is a need for a single beverage cooler capable of containing and/or dispensing both alcoholic and “energy” beverages to a consumer. Additionally, since consumers often prefer extremely cold beverages and alcoholic beverages freeze at a temperature below that of water, there is a need for a single beverage cooler that is capable of maintaining “energy” beverages at cool, but above freezing temperatures, and also maintaining alcoholic beverages at temperatures below the freezing point of water.

### BRIEF SUMMARY

According to an aspect of the invention a beverage cooler is provided. The beverage cooler includes a central beverage storage area and at least one external beverage dispensing unit. The central beverage storage area is generally in the shape of a cuboid, having a floor piece, ceiling piece, back piece, and two side pieces, and further having a front door piece. The external beverage dispensing unit includes an inlet, storage chamber, and outlet. The inlet may include an annular opening adapted to receive the neck of a bottle and to support the bottle in an inverted position at the bottle's “shoulder,” along with an internal retention area adapted to surround and maintain the bottleneck. The storage chamber is sealed and adapted to retain a liquid dispensed from the bottle inserted into the inlet. The outlet allows for on demand dispensing of the liquid from the storage chamber.

The beverage cooler further includes at least two compressors, wherein a first compressor is adapted to cool the central beverage storage area and a second compressor is adapted to cool at least one external beverage dispensing unit. The first compressor may cool the central beverage storage area via a forced air evaporator system. The second compressor may cool an external beverage dispensing unit via at least one cold plate, wherein the cold plate may be integrated within a wall of the storage chamber or in thermal contact with the storage chamber.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front perspective view of the dual compressor cooler;

FIG. 2 is a side view, shown in partial phantom, of one particular embodiment of the dual compressor cooler; and

FIG. 3 is a front view, shown in partial phantom, of one particular embodiment of the dual compressor cooler.

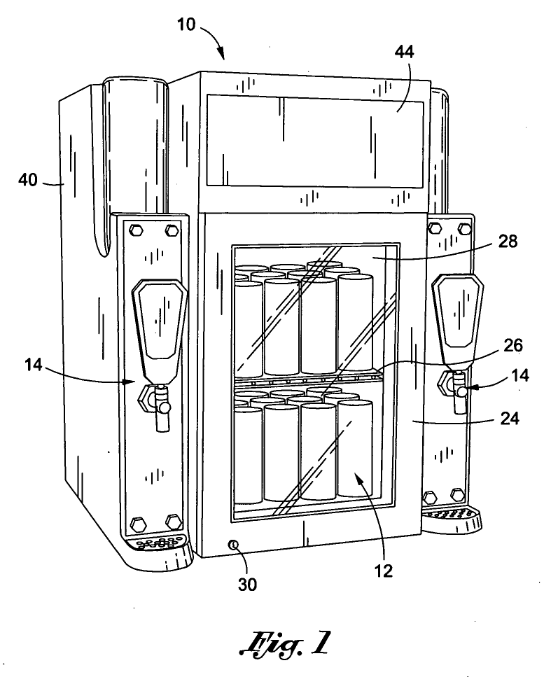

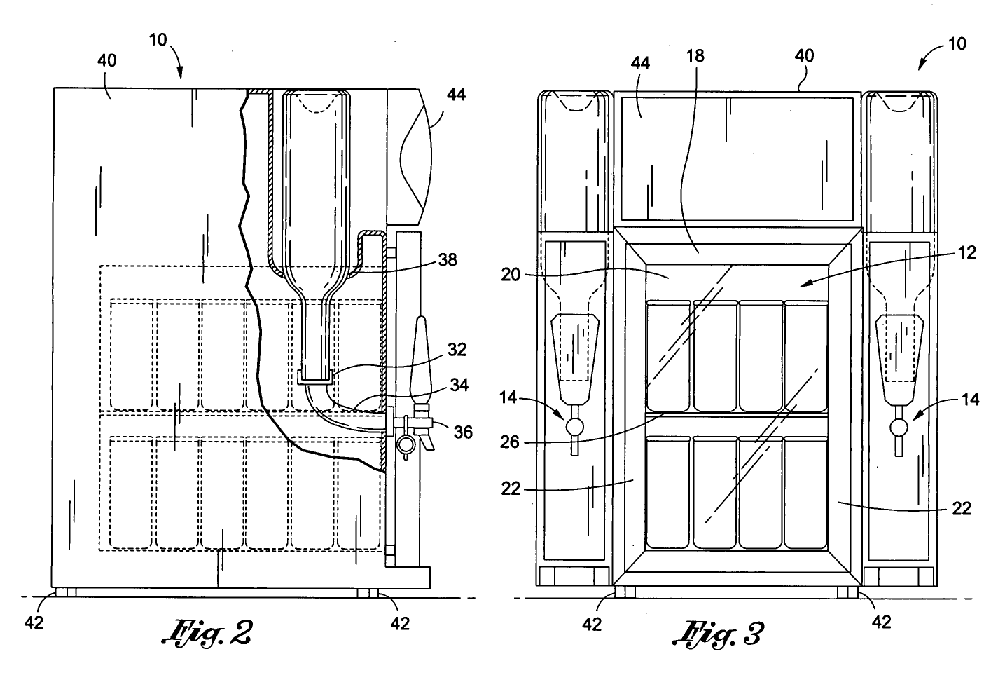

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings wherein the showings are for purposes of illustrating embodiments of the present invention only and not for purposes of limiting the same, shown is a dual compressor beverage cooler 10. The beverage cooler 10 includes a central beverage storage area 12 and at least one external beverage dispensing unit 14.

The central beverage storage area 12 is generally in the shape of a cuboid, having a floor piece 16, ceiling piece 18, back piece 20, and two side pieces 22, and further having a front door piece 24. The central beverage storage area 12 may further include at least one shelf 26. The shelves 26 may be adjustably locatable at various heights within the central beverage storage area 12. In one embodiment, the central beverage storage area 12 includes two powder-coated metal shelves 26, with a first shelf 26 being located approximately near the central beverage storage area floor 16 and a second shelf 26 being positioned at a point approximately halfway between the floor 16 and ceiling 18 of the central beverage storage area 12. This embodiment may be capable of containing a total of forty-eight beverage containers. In particular, one embodiment may be configured such as to be able to contain four beverage container across and six beverage containers deep per shelf, i.e., twenty-four beverage containers on each of two shelves for a total containment of forty-eight beverage containers. The central beverage storage area 12 may be adapted to hold bottles and/or cans containing alcoholic, non-alcoholic, “soft”, and/or “energy” beverages. In one embodiment, the central beverage storage area 12 is adapted to house “energy” drinks contained within aluminum cans of a distinct size and shape.

The dual compressor beverage cooler 10 may further include means of illumination located within the central beverage storage area. In one embodiment, the central beverage storage area 12 includes at least one light bulb (not shown) positioned horizontally along the internal side of the ceiling 18. The front door piece 24 may be any type of openable face piece; however, preferably the door piece 24 will include a transparent piece 28 so that the contents of the central beverage storage area 12 are visible to the outside without necessitating the opening of the front door piece 24. One embodiment of the present invention includes a double-paned glass door. The door 24 may further include a self-closing mechanism to help prevent the unnecessary loss of cool air from the central beverage storage area 12 after a user has removed any desired contents. The front door piece 24 may further include a locking mechanism 30 to help prevent unauthorized entrance to the central beverage storage area 12.

The external beverage dispensing unit 14 includes an inlet 32, storage chamber 34, and outlet 36. The inlet 32 may include an annular opening 38 adapted to receive the neck of a bottle and to support the bottle in an inverted position at the bottle's “shoulder,” along with an internal retention area adapted to surround and maintain the bottleneck. The inlet 32 may further include a lighted ring for illuminating the bottle supported by the annular opening 38. In one embodiment, the annular opening 38 further includes an LED light ring for illuminating the supported bottle. The LED light ring may be a solid color, may be lighted intermittently, and/or may change colors. The storage chamber 34 is sealed and adapted to retain a liquid dispensed from the bottle inserted into the inlet 32. The outlet 36 allows for on demand dispensing of the liquid from the storage chamber 34. The outlet 36 may comprise any suitable liquid dispensing device, including, but not limited to, conventional tap systems. The external beverage dispensing unit 14 may house any type of consumable beverage; however, in one embodiment the external beverage dispensing unit 14 is adapted to house alcoholic beverages. In another embodiment, the external beverage dispensing unit 14 houses vodka. In a particular embodiment, the dual compressor beverage cooler 10 includes two external beverage dispensing units 14, wherein a first unit is located on the left side of the central beverage storage area 12 and a second unit is located on the right side of the central beverage storage area 12. In this embodiment, the two external beverage dispensing units 14 may house the same or dissimilar beverages.

The beverage cooler 10 utilizes cooling apparatuses known within the art and further includes at least two compressors (not shown), wherein a first compressor is adapted to cool the central beverage storage area 12 and a second compressor is adapted to cool at least one external beverage dispensing unit 14. One embodiment of the present invention utilizes compressors capable of producing 0.1 horsepower. The first compressor may cool the central beverage storage area 12 via a forced air evaporator system. In one embodiment, the first compressor cools the central beverage storage area 12 to typical refrigeration temperatures, e.g., between approximately forty degrees Fahrenheit and approximately thirty-two degrees Fahrenheit (5° C.-0°). The second compressor may cool an external beverage dispensing unit 14 via at least one cold plate (not shown), wherein the cold plate may be integrated within a wall of the storage chamber 34 or in thermal contact with the storage chamber 34. In one embodiment, the second compressor cools the storage chamber 34 to a temperature below freezing, e.g., at a temperature at or below approximately 0° F. (−18° C.). In a particular embodiment, the storage chamber 34 has two cold plates (or evaporator coils) integrated within, or thermally connected to, the walls of the storage chamber 34. The second compressor may be connected to and configured to cool more than one external beverage dispensing unit 14. The cooling apparatuses and compressors may contain any suitable coolant known within the art or that may come available in the future. One embodiment utilizes R134A refrigerant. The beverage cooler 10 may further include an electronic temperature control for controlling and maintaining the temperature within the beverage cooler 10. The temperature of the central beverage storage area 12 and the external beverage dispensing units 14 may be controlled independently.

The beverage cooler 10, including central beverage storage area 12 and external beverage dispensing unit(s) 14 may be enclosed within an outer cabinet 40. In one particular embodiment the outer cabinet 40 has dimensions of 17″w×19.5−d×29.5″h. The outer cabinet 40 may be constructed from any suitable material, including, but not limited to, steel. The outer cabinet 40 may include adjustable levelers 42 located on the bottom of the outer cabinet 40, wherein such levelers 42 may be adjusted to position the beverage cooler 10 in a level fashion depending on the surface on which the beverage cooler 10 is located. The outer cabinet 40 may also include external badging or advertising materials. In particular, one embodiment includes an illuminated canopy header 44 which may contain marking of the beverages contained within the beverage cooler 10.

The above description is given by way of example, and not limitation. Given the above disclosure, one skilled in the art could devise variations that are within the scope and spirit of the invention disclosed herein, including various ways of storing and cooling the beverages and different configurations of beverage storage areas and external beverage dispensers. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A beverage cooler comprising:
a central beverage storage area having a floor piece, a ceiling piece, a back piece, two side pieces, and a front door piece;
at least one external beverage dispensing unit, the external beverage dispensing unit having an inlet, storage chamber, and outlet;
a first compressor adapted to cool the central beverage storage area; and
a second compressor adapted to cool the at least one external beverage dispensing unit.

2. The beverage cooler of claim 1, wherein the central beverage storage area further includes at least one shelf.

3. The beverage cooler of claim 1, wherein the central beverage storage area further includes at least one light bulb positioned horizontally along an internal side of the central beverage storage area ceiling.

4. The beverage cooler of claim 1, wherein the front door piece is transparent.

5. The beverage cooler of claim 1, wherein the external beverage dispensing unit inlet comprises an annular opening and an internal retention area.

6. The beverage cooler of claim 5, wherein the annular opening further comprises an LED light ring.

7. The beverage cooler of claim 1, wherein the storage chamber is sealed sufficiently to retain a liquid contained within said storage chamber.

8. The beverage cooler of claim 1, wherein the beverage cooler includes a first external beverage dispensing unit and a second external beverage dispensing unit and the second compressor is adapted to cool both the first and second external beverage dispensing units.

9. The beverage cooler of claim 1, wherein the first compressor is adapted to cool the central beverage storage area to a temperature between approximately 40° F. and approximately 32° F.

10. The beverage cooler of claim 1, wherein the second compressor is adapted to cool the storage chamber to a temperature below 32° F.

11. The beverage cooler of claim 10, wherein the second compressor is adapted to cool the storage chamber to a temperature at or below approximately 0°

12. The beverage cooler of claim 1, wherein the first compressor cools the central beverage storage area via a forced air evaporator system.

13. The beverage cooler of claim 1, wherein the second compressor cools the storage chamber via at least one cold plate.

14. The beverage cooler of claim 13, wherein the second compressor cools the storage chamber via two cold plates.

15. The beverage cooler of claim 1, further comprising a temperature control system adapted to control and maintain the temperature of the central beverage storage area.

16. The beverage cooler of claim 1, further comprising a temperature control system adapted to control and maintain the temperature of the external beverage dispensing unit.

17. A dual compressor beverage cooler comprising:
a central beverage storage area having a floor piece, a ceiling piece, a back piece, two side pieces, and a transparent front door piece;
two external beverage dispensing units, the external beverage dispensing units each having an annular opening, internal retention area, sealed storage chamber, and controllable outlet;
a first compressor adapted to cool the central beverage storage area to a temperature between approximately 40° F. and approximately 32° F.; and
a second compressor adapted to cool the two sealed storage chambers to a temperature below 32° F.
